(19) United States
(12) Patent Application Publication
(10) Pub. No.: US 2003/0194477 A1
(43) Pub. Date: Oct. 16, 2003

(54) Colloidal stabilization of beer

(75) Inventors: Mustafa Rehmanji, Bloomingdale, NJ (US); Andrew Mola, Wayne, NJ (US); Chandra V. Gopal, Middlesex (GB); Philip Cummins, Long Valley, NJ (US)

Correspondence Address: William J. Davis, Esq., INTERNATIONAL SPECIALTY PRODUCTS, Legal Dept., Bldg. 10, 1361 Alps Road, Wayne, NJ, 07470, US

(73) Assignee: ISP INVESTMENTS INC.

(21) Appl. No.: 10/439,134

(22) Filed: May 15, 2003

Related U.S. Application Data
(62) Division of application No. 09/645,948, filed on Aug. 25, 2000.

(51) Int. Cl. C12G 1/00

(52) U.S. Cl. 426/592

(57) ABSTRACT

A beer-haze stabilizer composite comprising, in parts by weight,

(a) about 5-20 of crosslinked polyvinylpyrrolidone,

(c) about 14 of papain,

(c) about 1-3 of an antioxidant, and

(d) about 1-3 of a foam enhancer.

### BACKGROUND OF THE INVENTION

1. Field of the Invention

This invention relates to colloidal stabilization of beer, and, more particularly, to removal of beer haze caused by complexation between polyphenols and proteins naturally present in beer.

2. Description of the Prior Art

Traditionally, lager beer has been stabilized against development of beer haze simply by physical storage for up to 3 months at near freezing temperatures, known as “cold maturation”. During standing much of the least soluble protein-polyphenol complexes aggregated as particles that could be readily removed by precipitation or filtration. Such cold-matured beer usually remained free from haze for several weeks; however, in time, the haziness reappeared in the beer. Chemical stabilization, on the other hand, can remove either the haze-producing polyphenols or proteins, or both, thus providing a beer with predictable colloidal stability over long periods of time.

Accordingly, it is an object of this invention to provide an improved chemical stabilization composite and process for efficient prevention or removal of beer haze.

### SUMMARY OF THE INVENTION

What is described herein is a beer-haze stabilizer composite which comprises, in parts by weight,

(a) about 5-20 of crosslinked polyvinylpyrrolidone (PVPP),

(b) about 1-4 of papain,

(c) about 1-3 of an antioxidant, and

(d) about 1-3 of a foam enhancer.

In a preferred form of the invention, the composite includes (a) about 10, (b) about 2, (c) about 2, and (d) about 2, parts by weight of the respective components.

As a feature of the invention, there is also provided herein an aqueous beer-haze stabilizer composition comprising about 5-15 wt. % of the composite described above, and about 85-95 wt. % water.

The process of removing haze from beer comprises treating beer with the composite, as an aqueous slurry, in the amount of about 8-30 g of the composite per hectaliter (hl) of beer, preferably about 16 g/hl.

Haze-stabilized beer which has been treated with the composite, as an aqueous slurry, is not susceptible to oxidation and can develop a desired level of foam in use, and substantially without residual papain therein.

The amount of papain introduced in the composite is sufficient to complex with hydrophilic proteins in beer which ordinarily cause haze when complexed with polyphenols.

### DETAILED DESCRIPTION OF THE INVENTION

Commercial papains include Collupulin® papain (Wallerstein Laboratories) and liquid papain (Quest PROFIX® 500).

The components of the beer-haze stabilizer composite of the invention and their function will be described in detail below.

(a) PVPP is crosslinked polyvinylpyrrolidone which is insoluble in beer, yet will adsorb polyphenols from beer.

(b) Papain is a proteolytic enzyme extracted from the green fruit of the papaya plant (Carica papaya). Commercial papains contain a mixture of at least ten different enzyme activities, the main proteolytic enzymes being papain and chymopapain. Papain is a sulfhydryl protease requiring activation by hydrogen sulfide and cysteine. The proteolytic action of papain is relatively broad; it hydrolyses proteins to peptides and amino acids. More particularly, it degrades the haze-forming proteins to such small molecular weights that association with polyphenols either do not occur, or, if they do, it does not contribute to the formation of visible haze in beer.

(c) A suitable commercial antioxidant product is Isona-D® available from Wallerstein Laboratories; it is a mixture of sodium dithionite and sodium iso-ascorbate (erythobrate). The dithionite reacts rapidly with oxygen present in solution in beer to form SO₂; thereafter the iso-ascorbate component reacts with oxygen at a slow rate to provide sustained protection from deleterious oxidation in the beer.

(d) An effective foam enhancer is esterified algin, e.g. propylene glycol alginate (Kelcoloid O) (ISP), which stabilizes foam in beer.

Thus the present invention provides a beer-haze stabilizer composite which simultaneously removes polyphenols which are precursors to the formation of more reactive polymerized polyphenols such as tannoids and proteins; imparts beer with a protective antioxidant, and enhances the foam cling time in beer. The attributes of the composite are available to the beer matrix as a single product which requires only a single addition to the beer to provide long-time haze stabilization.

The recommended dose rate in beer, as weight of composite/volume of beer is about 10 g/hl-15 g/hl, added to the beer stream in about a 10% slurry in de-aerated water in a single addition, suitably with an in-line proportioning pump. The typical point of addition is after fermentation, while the beer is being pumped to the maturation tank. The contact time in the maturation tank suitably is about 3-5 days, i.e. the residence time of beer in the maturation tank.

While the invention has been described with particular reference to certain embodiments thereof, it will be understood that changes and modifications may be made which are within the skill of the art. Accordingly, it is intended to be bound only by the following claims, in which:

What is claimed is:

1. A beer-haze stabilizer composite comprising, in parts by weight,
(a) about 5-20 of crosslinked polyvinylpyrrolidone,
(b) about 1-4 of papain,
(c) about 1-3 of an antioxidant, and
(d) about 1-3 of a foam enhancer.

2. A composite according to claim 1 in which (a) is about 10, (b) is about 2, (c) is about 2 and (d) is about 2.

3. An aqueous beer-haze stabilizer comprising about 5-15 wt. % of the composite of claim 1 and about 85-95 wt. % water.

4. An application formulation comprising about 8-30 g of said composite per hectaliter (hl) of beer.

5. A process of removing haze from beer which comprises treating beer with the composite of claim 1, as an aqueous slurry, in the amount of about 8-30 g of said composite per hl of beer.

6. A process according to claim 5 wherein said amount is about 16 g/hl.

7. Haze-stabilized beer which has been treated with the composite of claim 1, as an aqueous slurry, which has minimal susceptibility to oxidation and maintains a desired level of foam in use, and substantially without residual papain therein.

8. A haze-stabilized beer according to claim 7 wherein said amount of papain introduced is sufficient to complex with hydrophilic proteins in beer which ordinarily causes haze when complexed with polyphenols.
